(19) United States
(12) Patent Application Publication
(10) Pub. No.: US 2005/0144037 A1
(43) Pub. Date: Jun. 30, 2005

(54) Automatic system for medicaments

(76) Inventor: Wolfgang Geiger, Ansbach (DE)

Correspondence Address: Alexander J. Burke;Intellectual Property Department, 5th Floor, 170 Wood Avenue South, Iselin, NJ, 08830, US

(21) Appl. No.: 10/915,917

(22) Filed: Aug. 11, 2004

(30) Foreign Application Priority Data
Aug. 14, 2003 (DE) 10337415.9

(51) Int. Cl. G06F 17/60

(52) U.S. Cl. 705/2

(57) ABSTRACT

An automatic system (1) for medicaments comprises an operating device (4), a control unit (6), a data memory (7, 12) and a device (2) for storing and dispensing medicaments. The control unit (6) has an operational connection to
a reading device (5) that is provided for acquiring data identifying the requested medicaments,
a comparison module (8) provided for comparing the data acquired by means of the reading device (5) with data stored in the data memory (7, 12) and relating to the medicaments present in the device (2) for storing and dispensing medicaments, and
a data output device (9) for outputting information determined with the aid of the comparison module (8).

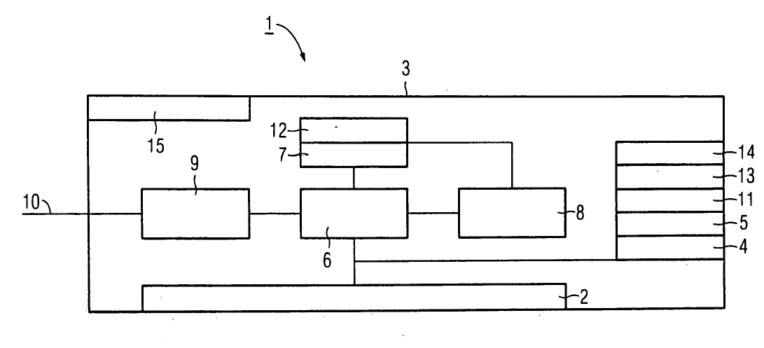

The invention relates to an automatic system for medicaments having an operating device, a control unit, a data memory and a device for storing and dispensing medicaments. Such an automatic system for medicaments is known from DE 696 24 125 T2, for example.

The automatic system for medicaments known from DE 696 24 125 T2 can, for example, be integrated into a data network in such a way that pharmacists have possibilities for accessing the automatic system for medicaments from various locations. The dispensing of a drug can be initiated in real time at the request of a pharmacist.

A further generic automatic system for medicaments is known from DE 690 17 365 T2, for example. This micro-processor-controlled automatic system for medicaments comprises various dispensers that are designed for medicament packages of different shape and size. The automatic system for medicaments can process patient profile information available in a hospital system.

An automatic system for medicaments known from DE 200 01 038 U1 is provided for the purpose of presenting an individual patient with medicaments on a regular basis. It is regarded as essential in this case that the patient take specific medicaments regularly and punctually according to a sequence prescribed by the doctor. The patient, in particular a person requiring care, is reminded, for example by acoustic signals, that a specific medicament is to be taken. There is no provision to supply a plurality of patients by means of the automatic system for medicaments.

It is the object of the invention to specify an automatic system for medicaments that is suitable, in particular, for supplying a plurality of patients.

This object is achieved according to the invention by means of an automatic system for medicaments having the features of claim 1. In addition to an operating device, a control unit, a data memory and a device for storing and dispensing medicaments, this automatic system for medicaments has a reading device, in particular a prescription scanner, a comparison module and a data output device. The reading device, which can also be provided for acquiring information transmitted electronically, is provided in general for acquiring data that identify the medicaments requested by the patient and to be taken from the automatic system for medicaments. The data acquired by means of the reading device are compared by means of the comparison module with data that relate to the medicaments present in the device for storing and dispensing medicaments. The data output device is provided, in particular, for print output and/or for long-distance information transmission, preferably in a medical information system. The data output to the patient or passed on in some other way relate to information determined with the aid of the comparison module. This information is, in particular, data relating to the medicaments given to the patient by the automatic system for medicaments and, if appropriate, relating to the medicaments requested by the patient but not in stock in the automatic system for medicaments. In the last-named case, it is preferred to transmit an order automatically to a supplier, in particular to a pharmacy.

It is provided according to a preferred refinement to store data that go beyond the simple identification of the medicaments. In particular, medicament-specific additional data include data on dosage, side effects and interactions of medicaments. In a particularly preferred way, an additional data memory also comprises patient-specific data going beyond the identification of the patient, which are, in particular, coordinated with an electronic patient file. These patient-specific additional data are preferably combined with the stored and/or medicament-specific additional data available to a medical information system, such that it is possible to use the data output device to pass on to the patient or to some other party, for example doctor or pharmacist, information individually tailored to the patient, for example information relating to interactions or intolerabilities. An interaction database integrated in the automatic system for medicaments or combined with the latter using data technology can preferably be evaluated in an individualized fashion by calling in patient-specific data.

A data memory integrated in the automatic system for medicaments or connected to the latter further preferably comprises a payment database that is provided for exchanging data with a drugs payment authority. It is preferred to provide as part of the automatic system for medicaments a payment means input device for payment by cash, payment by check or other form of payment, for example per patient's drugs card.

According to a preferred development, the automatic system for medicaments has a user identification device. The identification of the user, that is to say the patient, as a rule, is performed in this case, for example, by means of a personal identification number (PIN) and/or with the aid of biometric features, for example of a fingerprint or of the iris. A patient's card is likewise suitable for monitoring the giving of drugs and/or for controlling the access to a medical information system connected to the automatic system for medicaments.

A substantial additional benefit is provided by a diagnosis module of the automatic system for medicaments. In this case, the diagnosis module is preferably provided for carrying out simple diagnostic tests, for example relating to DNA, protein, chemical compounds, minerals. The data obtained by means of the diagnosis module are preferably stored in the data memory of the automatic system for medicaments and/or transmitted into the medical information system, if appropriate. An electronic interface between diagnosis and therapy is thereby produced. The diagnosis module is advantageous, in particular, for dispensing medicaments to chronically ill patients. With this patient group, it is possible to provide use of the automatic system for medicaments even without a doctor's prescription in individual cases. It is presupposed here that a limited supply of medicaments are released by the doctor via the medical information system. The data obtained by means of the diagnosis module are advantageously incorporated into the determination of the quantities to be given to the patient.

In order to comply with ambient conditions suitable for storing medicaments, it is preferred to provide a temperature-control module, in particular a heating, cooling and/or dehumidifying system, in the automatic system for medicaments. The temperature and moisture values measured in the automatic system for medicaments are preferably remotely monitored.

The advantage of the invention resides, in particular, in that an automatic system for medicaments whose control combines a user identification device and a prescription reading device with a memory comprising both patient-specific and medicament-specific data permits drugs to be given to a multiplicity of patients in a controlled fashion coordinated with the individual requirements and restrictions.

An exemplary embodiment of the invention is explained in more detail below with the aid of a drawing, in which the sole FIGURE shows an automatic system for medicaments in a schematic way.

An automatic system 1 for medicaments illustrated symbolically in the FIGURE is set up as a goods merchandiser, for example in the waiting room of a doctor, in hospital, in a pharmacy or at other health service providers, or else at specially trained retailers. As a rule, the automatic system 1 for medicaments is therefore located in a controlled environment. If it is envisaged to set up the system in regions where access is unrestricted or allowed to the public under certain conditions, there is a need to protect the automatic system 1 for medicaments against vandalism. The automatic system 1 for medicaments, also denoted as an electronic pharmacy assistant, can have any desired basic shape—for example rectangular, cylindrical or spherical—irrespective of the location where it is set up. Likewise, the automatic system 1 for medicaments can, for example, be suspended on a wall or—like an automatic bank teller—be integrated in a building.

The medicaments in stock in the automatic system 1 for medicaments are located, generally in commercial packages, in a device 2 for storing and dispensing medicaments. This device is designed, for example, as a closed structural unit or in the form of a goods dispenser connected to an automatic consignee. The principle of the functioning and the design of the device for storing and dispensing medicaments is, for example, along the lines of conventional goods dispensers such as automatic cigarette dispensers. All the components of the automatic system 1 for medicaments that are explained in more detail below are located inside a housing 3 in the exemplary embodiment. There is also the possibility, in fact, of storing individual ones of these components, for example in an external data processing system.

The user, that is to say the patient, in general, operates the automatic system 1 for medicaments by means of an operating device 4 that has keys (not illustrated), for example. It is preferred for the automatic system 1 for medicaments to be provided at least chiefly for giving medicaments requiring a prescription. A reading device 5 in the form of a scanner is provided for the purpose of reading a prescription input, that is to say laid or inserted, into the automatic system 1 for medicaments. A storage device (not illustrated) is provided for preserving the prescriptions in the automatic system 1 for medicaments. Instead of the data that identify the medicaments requested by the patient being input by a written prescription, they can also be input by means of some other data carrier or by long-distance data transmission. In any case, the request for medicaments is passed on to a control unit 6. The latter has a connection to a data memory 7 that contains information on the type and quantity of the medicaments in stock in the automatic system 1 for medicaments. The information read out from the data memory 7 is compared in a comparison module 8 with the request for medicaments. If all the requested medicaments are in stock, the patient who removes the medicaments from the device 2 for storing and dispensing medicaments receives a printed confirmation produced by means of a data output device 9. The data output device 9 is also connected to a medical information system 10. Via the latter, the data acquired in the automatic system 1 for medicaments is passed on to a drugs payment authority. If not all the medicaments requested by the patient are in stock in the automatic system 1 for medicaments, an electronic order is simultaneously placed with a supplier who initiates the dispatch of the outstanding drugs to the patient's address. In this case, the patient obtains from the automatic system 1 for medicaments a written confirmation of the order placed.

In order to identify the patient, the automatic system for medicaments has a user identification device 11 that preferably operates by biometric identification. It is provided in addition or as an alternative for the chip card to be read out or for a numerical code to be input. The use of the automatic system 1 for medicaments by a specific patient must be cleared as a rule before first-time use. Such a clearance is preferably performed via the medical information system 10. An additional data memory 12, also denoted as additional memory for short, comprises patient-specific additional data that, in particular, are also contained in an electronic patient file and are exchanged via the medical information system 10.

Furthermore, the additional data memory 12 also comprises medicament-specific additional data relating to the medicaments in stock in the automatic system 1 for medicaments and/or to the medicaments requested by the patient. This medicament-specific additional data relating, for example, to interactions and side effects are correlated with the data input by the patient as well as with the additional data stored relating to the patient. This provides a possibility of selectively outputting information relating to the patient personally via the data output device 9. This information is, for example, advice on possible interactions between the medicaments requested by the patient, or advice on side effects that may effect the patient because of the latter's specific clinical picture. In addition to an interaction database, there is also a payment database, preferably like the database in the additional data memory 12, that is provided for exchanging data with the supplier of the medicaments and with other service providers. The automatic system 1 for medicaments thus provides functions that go far beyond the dispensation of medicaments. In the case of inconsistencies between the input data and those stored, for example the request for medicaments that are extremely likely not to be required personally by the patient when account is taken of the latter's state of health, provision is made for an appropriate message to be passed on directly to the patient via the medical information system 10, and/or for a warning to be issued directly to the patient.

A substantial additional benefit of the automatic system 1 for medicaments, which considerably extends its individualized functioning, is given by a diagnosis module 13. The latter is preferably provided for use without medical specialists, the patient having a minimum quantity of blood taken without being troubled by means of a microneedle array, for example. The diagnosis module 13 is particularly suitable for monitoring chronically ill patients. The frequency of visits by the doctor can thereby be substantially reduced. For example, a specific quantity of drugs that has to be taken by the patient from the automatic system for medicaments within a fixed time period can, for example, be released by the doctor in advance for the entire time period, for example a month. In addition to examinations that are to be carried out by the doctor at relatively large time intervals, the patient is monitored by means of the diagnosis module 13 in shorter intervals, the quantity of the drugs dispensed by the automatic system 1 for medicaments preferably depending on the data acquired by means of the diagnosis module 13.

A payment means input device 14 is provided for paying by means of cash, check card, cash card or in any other way desired. All the data relating to payments made are passed on to the medical information system 10. Provided for the purpose of complying with prescribed ambient conditions for storing medicaments is a temperature-control module 15 that keeps the temperature and atmospheric humidity constant within prescribed limits in the housing 3 and is required, in particular, for setting up the automatic system 1 for medicaments in the open air. Just like a data link to the control unit 6, an energy supply device of the temperature-control module 15 is not illustrated.

When setting up the automatic system 1 for medicaments in a medical practice, the doctor consults with the operator of the automatic system 1 for medicaments to stipulate the basic medication of the automatic system 1 for medicaments, that is to say the most frequently required assortment of drugs. Existing hurdles, such as the distribution prohibition for doctors and the status of drugs as special goods, are taken into account with the automatic system 1 for medicaments set up, for example, in the waiting room. Moreover, the automatic system 1 for medicaments can be incorporated in a particularly effective way into a medical quality assurance system. The combination with electronic patient files as part of the medical information system 10 permits the patients' medication to be individualized simply. The number of patients who use the automatic system 1 for medicaments is not fundamentally limited in this case.

In a way similar to an automatic bank teller, for example, the automatic system 1 for medicaments can be set up in a room that is accessible without a time limitation to authorized persons, that is to say persons who can establish their identity by means of an electronically readable card in particular. In a particularly advantageous way, the automatic system 1 for medicaments can also be used for ordering medicaments owing to its connection to the medical information system 10. In this case, the patient places an order under an order code and can thereby reserve the ordered medicament at an automatic system of his choice. The order code is to be input anew when the medicament is collected at the automatic system 1 for medicaments. Furthermore, a prescription is to be laid in the reading device 5, or the collection of the medicament is to be cleared by an authorized authority via the medical information system 10. If the medicament is not collected within a prescribed time interval from the automatic system 1 for medicaments, a message to the medical information system 10 can be generated and/or delivery directly to the patient can be arranged.

The automatic system 1 for medicaments is incorporated in a merchandizing system via the medical information system. A payment database is indicated in the additional data memory 12, or is provided at another location within the medical information system 10. The number of the various medicaments in stock in the automatic system 1 for medicaments is typically approximately 30, but is not subject to any restrictions. The shelf lives of the medicaments stored in the device 2 for storing and dispensing are stored in the data memory 7 or in the additional data memory 12, which are shown as separate memories merely to illustrate the diagrammatic design, and are monitored. Before expiry of the minimum shelf life, the operator of the automatic system 1 for medicaments is sent a message via the medical information system 10.

1. An automatic system for medicaments having an operating device (4), a control unit (6), a data memory (7, 12) and a device (2) for storing and dispensing medicaments, the control unit (6) having an operational connection to
a reading device (5) that is provided for acquiring data identifying the requested medicaments,
a comparison module (8) provided for comparing the data acquired by means of the reading device (5) with data stored in the data memory (7, 12) and relating to the medicaments present in the device (2) for storing and dispensing medicaments, and
a data output device (9) for outputting information determined with the aid of the comparison module (8), characterized by a diagnosis module (13) provided for carrying out diagnostic tests.

2. The automatic system for medicaments as claimed in claim 1, characterized in that the data memory (7, 12) is provided for storing data obtained by means of the diagnosis module (13).

3. The automatic system for medicaments as claimed in claim 1 or 2, characterized in that the diagnosis module (13) comprises a microneedle array suitable for blood sampling.

4. The automatic system for medicaments as claimed in one of claims 1 to 3, characterized in that the diagnosis module (13) cooperates with the device (2) for storing and dispensing medicaments in such a way that the quantity of the drugs dispensed is a function of the data acquired by means of the diagnosis module (13).

5. The automatic system for medicaments as claimed in one of claims 1 to 4, characterized in that the data output device (9) is provided for print output.

6. The automatic system for medicaments as claimed in one of claims 1 to 5, characterized in that the data output device (9) is provided for long-distance information transmission.

7. The automatic system for medicaments as claimed in one of claims 1 to 6, characterized by an additional data memory (12).

8. The automatic system for medicaments as claimed in claim 7, characterized in that the additional data memory (12) is provided for storing medicament-specific additional data.

9. The automatic system for medicaments as claimed in claim 7 or 8, characterized in that the additional data memory (12) is provided for storing patient-specific additional data.

10. The automatic system for medicaments as claimed in claims 8 and 9, characterized in that the comparison module (8) is provided for combining medicament-specific additional data with patient-specific additional data.

11. The automatic system for medicaments as claimed in one of claims 8 to 10, characterized in that the additional data memory (12) comprises an interaction database.

12. The automatic system for medicaments as claimed in one of claims 8 to 11, characterized in that the additional data memory (12) comprises a payment database.

13. The automatic system for medicaments as claimed in one of claims 1 to 12, characterized by a payment means input device (14).

14. The automatic system for medicaments as claimed in one of claims 1 to 13, characterized by a connection to a medical information system (10).

15. The automatic system for medicaments as claimed in one of claims 1 to 14, characterized by a user identification device (11).

16. The automatic system for medicaments as claimed in one of claims 1 to 15, characterized by a temperature-control module (15).
